(19) United States
(12) Patent Application Publication
(10) Pub. No.: US 2006/0285832 A1
(43) Pub. Date: Dec. 21, 2006

(54) Systems and methods for creating and recording digital three-dimensional video streams

(75) Inventor: Qiang Huang, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: River Past Corporation, San Francisco, CA (US)

(21) Appl. No.: 11/155,127

(22) Filed: Jun. 16, 2005

(51) Int. Cl. H04N 5/00

(52) U.S. Cl. 386/117; 348/51

(57) ABSTRACT

Systems and methods for creating digital three-dimensional video streams utilizing digital input video streams. Software is used to merge two digital video input streams through three-dimensional processing methods to create the digital three-dimensional video stream. The digital three-dimensional video stream may be previewed during or after processing to allow for adjustment of the digital input video streams.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

1. Field of the Invention

The present invention relates to systems and methods for creating three-dimensional video images, and more particularly, to systems and methods for creating three-dimensional video streams.

2. Description of the Prior Art

Three dimensional (3-D) stereo images or videos utilize different views with respect to each of a viewer's two eyes in order to create the three dimensional perspectives. There are several methods known in the art. Specifically, some of the more common methods include anaglyph, a liquid crystal display (LCD) shutter glass method, a cross-eye method, and a parallel viewing method.

With the anaglyph method, the anaglyphs are still or moving pictures where the red and blue (green or cyan) channels have been split and then reassembled so that the image appears three dimensional when viewed through 3-D glasses with red and blue (green or cyan) lenses.

Two images or videos of the same subject from generally side-by-side perspectives are taken with two cameras. A red filter is applied to the left image or video. A blue (green or cyan) filter is applied to the right image or video. The two images or videos are then overlaid together. The viewer must therefore wear a pair of anaglyph glasses with a red filter on the left eye and a blue (green or cyan) filter on the right eye such that the left eye only sees the image or video from the left camera and the right eye only sees the image or video from the right camera. The two eyes thus see different videos and thus, form the three dimensional perspective.

Color filter glasses have been used in 3-D movies and some early computer games. The advantage of the anaglyph method is that the 3-D material may be stored on any standard color video media and viewed with normal display devices as long as one wears the correct color filter glasses. Such glasses are generally very inexpensive because only very cheap plastic filters are needed for them. One may even make glasses from a piece of cardboard and suitable filters.

With gray scale anaglyph, the images or videos are converted to gray scale prior to the color filters being applied. The 3-D effect is generally more clear since both eyes are looking at the same gray-scale model.

With the color anaglyph method, the color images or videos are processed with color filters directly. It is thus possible to create 3-D images or videos with vivid colors using this method. However, sometimes the 3-D perspective is confusing to the human eye. For example, a object red will appear bright in the left eye, but dark to the right eye.

With the LCD shutter glass method, the left and right images in the LCD shutter glass 3-D display are alternated rapidly on the monitor screen. When the viewer looks at the screen through shuttering eyewear, each shutter is synchronized to occlude the undesired image and transmit the desired image. Thus, each eye sees only its appropriate perspective view. The left eye sees only the left view and the right eye sees only the right view.

A field-sequential 3-D (stereoscopic) video signal is a normal video signal (PAL, NTSC or SECAM) that has been specially recorded with left and right images stored on the even and odd fields of the video signal. The 3-D video signal is usually viewed while wearing a pair of LCD shutter glasses that only allow the left eye to see the left images and the right eye to see right images.

If the images (the term “fields” is often used for video and computer graphics) are refreshed (changed or written) fast enough (often at twice the rate of the planar display), the result is a flickerless stereoscopic image. This kind of display is referred to as a field-sequential stereoscopic display.

With the cross-eye method, when one assembles the cross-eye image, one needs to swap left/right, since one is, after all, crossing their eyes. It is important that one also vertically align the images so that objects line up. The two pictures are placed side-by-side, with the left picture on the right and the right picture on the left.

With the parallel method, the exact direction each camera is pointing is important, as it is vital that the two pictures in the pair be taken in the same direction (parallel, not converging). The pictures are placed side-by-side, with the left picture on the left and the right picture on the right.

Since the parallel viewing method requires the two eyes to focus to infinite distance to make their focus line parallel, the two pictures must be placed so the distance between the center of the pictures is equal to the distance between the two eyes. Thus, the pictures cannot be very large. Assuming the distance between eyes is around 3 inches, the width of the picture cannot exceed 3 inches. If the picture width is smaller than 3 inches, there needs to be a gap between the two views. Since each person's eye distance is slightly different, it is impossible to make a static parallel viewing image to suit everyone. Thus, the parallel viewing method is much less common than cross-eye method.

Since the parallel and cross-eye methods require the viewer to control the focus of each eye to an unnatural point, they require practice and not everyone can master the control to get the 3-D effect. In addition, since the focus is not on the picture (about half distance for cross-eye, infinity for parallel), the picture will generally not appear clear and in-focus to the viewer. The 3-D effect will look fuzzy and the viewing is unnatural. Thus, the best viewing method is generally anaglyph and shutter-glass.

Unfortunately, there are problems associated with making persuasive 3-D photos or videos with current prior art systems, which is schematically illustrated in FIG. 1. First of all, two cameras 10, 11 are needed. The two cameras need to be kept aligned within close tolerances on all three axes. This is very difficult to accomplish. The two lenses must be located at the same exact level, the two lenses must be pointing to the same level, the two lenses must have the same focal length, the two lenses must have the same focus point, and the two lenses must point to the same point 12 located at the same distance to the two lenses. FIG. 1 schematically illustrates the necessary arrangement.

To ensure that the lenses are aligned correctly, a lot of efforts have been made. Generally, there are two approaches. A first approach involves specially designed stereo cameras with two lenses that include numerous mechanical inventions to keep the lens zoom at the same pace, or to focus at the same point. A second approach involves specially designed racks that hold two individual cameras together and provides methods to align some aspects (level and direction) of the cameras.

With either approach, the resulting videos are normally recorded as two video streams on analog tapes. The two videos are then processed separately to create the final 3-D video. It is a lengthy, time-consuming process that is error-prone, resulting from the extremely rigid requirement for camera alignments.

It is possible to record one three-dimensional video using the field-sequential three-dimensional method if the two videos run through a hardware stereo multiplexer. This may allow for a preview of the 3-D analog video on a television monitor while filming. However, the stereo multiplexer degrades the quality of the film and it is difficult to bring the multiplexer to computers for editing.

If the preview is not available with the hardware stereo multiplexer, then a cameraman must depend on the alignment of the stereo camera or the rack. If anything is out of alignment, the problem is not discovered until later when the videos go through the editing process and are multiplexed into the three dimensional video. A mistake with the shooting can mean that the entire scene is useless.

Additionally, in either case, the costs are very high, from thousands of dollars to tens of thousands of dollars. Shooting three dimensional video requires expertise in the field, good and reliable equipment, time, and money. This makes three dimensional video only possible for professional studios.

### SUMMARY OF THE INVENTION

The present invention provides a method of creating digital three-dimensional video information with a system comprising a processor, a user input, and a display device. The method includes providing first digital video information and second digital video information to the processor, and processing the first and second digital video information with the processor to create digital three-dimensional video information. At least a portion of the digital three-dimensional video information is displayed on the display device. The portion of the digital three-dimensional video information is reviewed and processing of the first and second video information is altered based upon the review of the portion of the digital three-dimensional video information. Processing of the first and second digital video information comprises merging the first and second digital video information and altering processing of the first and second video information comprises adjusting alignment of the first and second video information for merging.

In accordance with one aspect of the present invention, the first and second digital video information are digital video streams and the digital three-dimensional video information is a digital three-dimensional video stream.

In accordance with another aspect of the present invention, the first digital video stream and the second digital video stream are provided by one of a group comprising a web cam, a digital video camcorder, a high definition camcorder, a DVD camcorder, a digital video file, an Internet stream, and an on-line chat stream.

In accordance with a further aspect of the present invention, the first and second digital video streams are provided by a single digital video file that includes two separate video streams.

In accordance with yet another aspect of the present invention, the first and second digital video streams are provided by two separate digital video files.

In accordance with a further aspect of the present invention, the user input controls at least one of providing the first and second digital video streams, the processing of the first and second digital video streams, and altering of the processing of the first and second digital video streams.

In accordance with a further aspect of the present invention, a digital audio stream is provided to the processor and is included with the three-dimensional video stream.

In accordance with another aspect of the present invention, the digital audio stream is provided by one of a microphone, a camcorder, a digital audio file, an audio stream from the Internet, an audio stream from an on-line chat location, and an analog source.

In accordance with a further aspect of the present invention, the processing is done by a processing method from a group of three-dimensional processing methods comprising anaglyph, shutter glass, cross-eye and parallel.

The present invention also provides a system for creating digital three-dimensional video information where the system includes a processor, a source of first and second digital video information communicatively coupled to the processor, a user input communicatively coupled to the processor, a display communicatively coupled to the processor, and a processor-readable medium that includes program code for processing the first and second digital video information to create digital three-dimensional information, program code for displaying a preview of the digital three-dimensional video information on the display, and program code for altering processing of the first and second video information. The user input may be used to alter processing of the first and second digital video information based upon the preview of the digital three-dimensional video information. Processing of the first and second digital video information comprises merging the first and second digital video information. Altering processing of the first and second video information comprises adjusting alignment of the first and second video information for merging.

In accordance with another aspect of the present invention, the processor-readable medium may be one of a group comprising RAM, ROM, and a mass storage.

In accordance with a further aspect of the present invention, the processor-readable medium may be portable.

The present invention also provides a processor-readable medium containing program code for processing first and second digital video steams to create a digital three-dimensional video stream. The medium comprises program code for processing of the first and second digital video streams from a group of three-dimensional processing methods comprising anaglyph, shutter glass, cross-eye and parallel. The medium further comprises program code for displaying a preview of the digital three-dimensional video stream on a display, and program code for altering processing of the first and second video streams based upon the preview. The processing of the first and second digital video streams comprises merging first and second digital video streams and altering processing of the first and second video streams comprises merging first and second digital video streams and altering processing of the first and second video streams comprises adjusting alignment of the first and second video streams for merging.

Other features and advantages of the present invention will be apparent upon review of the following detailed description of preferred exemplary embodiments.

### BRIEF DESCRIPTION OF THE DRAWINGS

FIG. 1 is a schematic illustration of a prior art arrangement for filming for a 3-D video;

FIG. 2 is a schematic illustration of a system for creating a 3-D video in accordance with the present invention;

FIG. 3 is a schematic illustration of components for the system for creating a 3-D video in accordance with the present invention;

FIG. 4 is a flow chart illustrating anaglyph processing for creating a 3-D video;

FIG. 5 is a flow chart illustrating shutterglass processing for creating a 3-D video; and,

FIG. 6 is a flow chart illustrating cross-eye or parallel processing for creating a 3-D video.

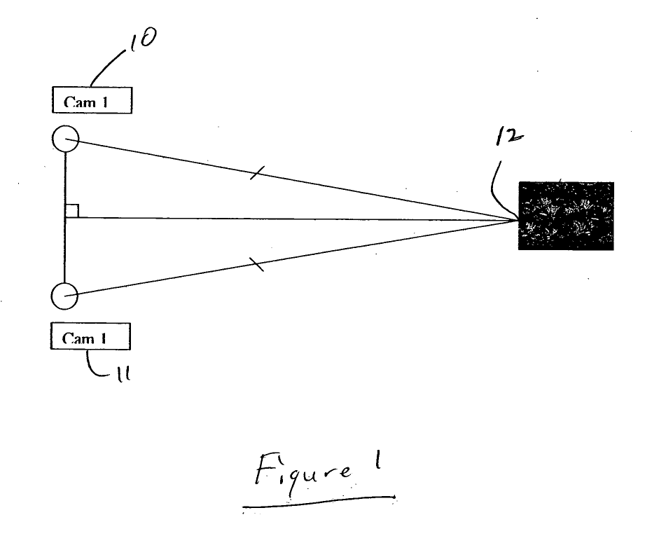

### DETAILED DESCRIPTION OF THE INVENTION

With reference to FIG. 2, it may be seen that the present invention provides a system 20 for digitally creating a three-dimensional image or video. In general, two pieces of video information 21, 22 are created by an input portion 23. Optional audio information 24 may also be provided by the input portion. The two pieces of video information are forwarded to a processing portion 25, along with any optional audio information, where they are processed to create three-dimensional video information 26. The three-dimensional video information and optional audio information are provided from the processing portion to an output portion 27, where they may be displayed, stored or sent to another system.

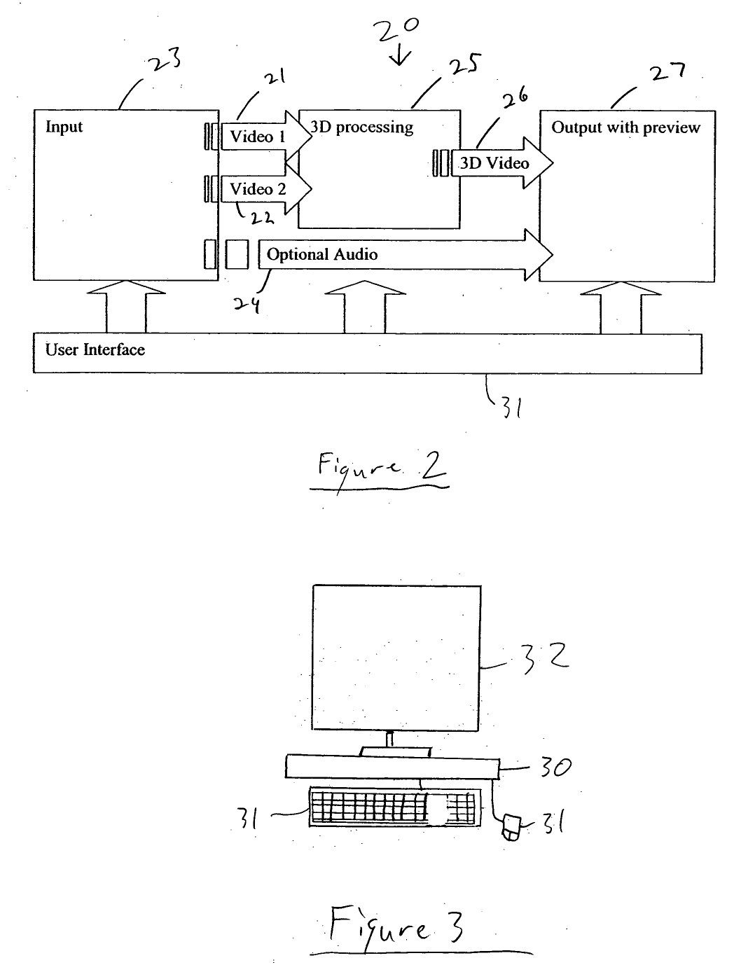

With reference to FIG. 3, processing portion 25 and output portion 27 comprise a processor 30, at least one user interface 31 and display 32. Processor 30 may be any type of computer or computing device known in the art that generally includes a central processing unit (CPU), memory such as, for example, a hard drive, RAM and ROM, and other peripheral devices. User interface 31 may be any type of interface known in the art such as a keyboard, a mouse, a touch screen (with display 32), etc. Those skilled in the art will understand that the present invention may be practiced with a computer system without a hard drive. The three-dimensional video may be saved directly to a writable CD or DVD media or memory card. For example, it is possible to implement the present invention on a game console coupled to a CD writer.

In accordance with the present invention, the three-dimensional video information may be previewed on display 32 prior to completion or outputting of the final three-dimensional video information. The preview may be a simple review of a portion of the three-dimensional information as it is being processed by the processing portion. The user may then adjust the input video information, and if necessary, the optional audio information, in order to obtain the desired three-dimensional video information. Thus, user interface 31 controls at least one of the input portion, the three-dimensional processing portion, and the output portion, and preferably controls all three.

In a first embodiment of the present invention, the input portion of the system includes two webcams. The webcams are placed side-by-side so that they may capture two stereoscopic perspectives of an image or scene. The webcams provide this digital video information or video streams to the processing portion. The user interface selects which webcam is used for the left video stream and which webcam will be used for the right video stream. If an optional audio stream is to be included, the user interface will select the source of the audio information or stream. The audio stream may be obtained from a microphone or microphones on the webcams, a soundcard, a digital audio file, an audio stream from the Internet, an audio stream from an on-line chat location on the Internet, or an analog source. The user interface preferably handles selection of the audio stream.

In alternative environments, the input digital video streams may be provided by digital video camcorders, a digital video file, an Internet web location, or an Internet on-line chat connection.

With the digital video camcorders, once again the camcorders are arranged in a side-by-side relationship to provide a right and left perspective or a stereoscopic image. If desired, the audio stream may be provided by a microphone on one of the camcorders.

In an instance where a digital video file is used to provide the stereoscopic images, the digital video file may include two separate video streams in one file, or two separate digital video files may be used to provide the right and left images.

In the embodiment where the video streams are provided by the Internet, either a website or an on-line chat room-type connection, two different video streams are provided for use as the right and left video information.

As noted above, the video streams are provided to a processing portion. As previously noted, the processor is some type of computing device. The processor is able to perform three-dimensional video processing such as anaglyph, shutter glass, cross-eye and parallel. If anaglyph processing is used, the processor is capable of performing either gray-scale or color anaglyph processing.

Program code is included on a processor-readable medium for performing the desired three-dimensional processing. The processor-readable medium may be, for example, portable, wherein it may be, for example, a compact disk, a DVD, a floppy disk, or some other type of portable memory. Additionally, the processor-readable medium may be resident on the processor in the form of, for example, some type of RAM, ROM, or may be resident on the hard drive or some other type of mass storage.

With reference to FIG. 4, if anaglyph three-dimensional processing is used, two video streams are provided to the processor. If the video streams are compressed, then the video streams are decoded. If desired, the video streams are changed to gray scale. In accordance with typical anaglyph processing, preferably the left video stream has a red filter applied thereto while the right video stream has either a blue, green or cyan filter applied thereto. Generally, for color anaglyph three-dimensional processing, cyan is used. In general, a user controls the color filter selection and/or whether to create gray scale anaglyph or color anaglyph.

The two video streams are then merged through an overlay process by taking the red value from the left video and taking the blue, or green (or both for cyan) values in the right video and combining these values to form a digital three-dimensional video stream.

For speed optimization, it is preferable to merge the step of changing to gray scale, the step of adding the color filter and the overlay step into one algorithm. Generally, the color filter and overlay are performed in a single step. The change to gray scale step may be done in the same step, or separately, if desired. Thus, it is possible and often desirable to perform two or all three steps substantially simultaneously during processing.

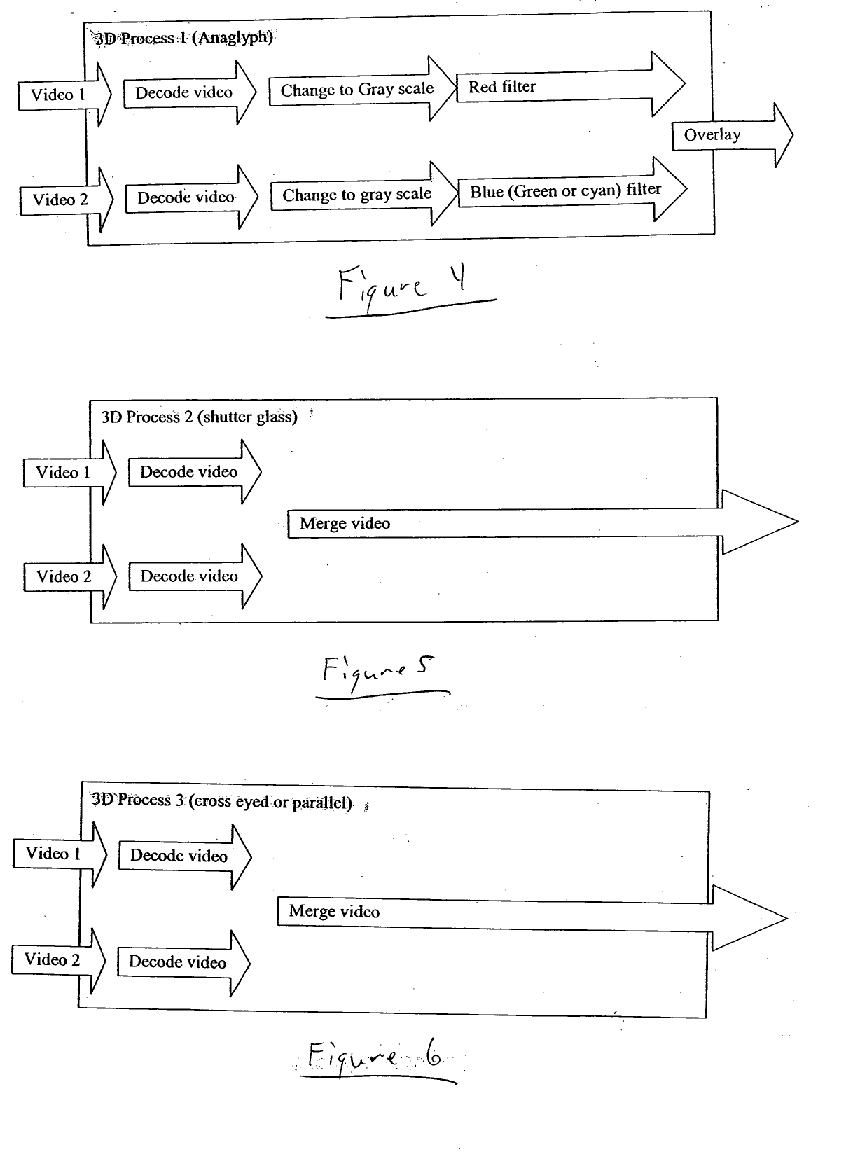

With reference to FIG. 5, if the shutter glass three-dimensional video processing method is desired, the two video streams are provided to the processor. The video streams are decoded if the video streams are compressed. The video streams are then processed by taking one frame from one of the video streams, for example, the left video stream, and then another frame from the other video stream, for example, the right video stream, in order to form a new three-dimensional video stream in a predetermined frame rate with alternate images from each video. If the field sequential shutter glass three-dimensional video processing method is used, the video streams are processed by taking one frame from video 1, place in one field in the output video, and taking one frame from video 2, place in the other field in the output video.

With reference to FIG. 6, for the three-dimensional processing method using either the cross-eye or parallel method, the two video streams are provided to the processor and they are decoded if they are compressed. The merging of the video streams is performed by placing the images from the two video streams side-by-side. For the cross-eye three-dimensional effect, the left image is placed on the right and the right image is placed on the left. For the parallel three-dimensional effect, the left image is placed on the left and the right image is placed on the right. The two video streams are then merged to form a digital three-dimensional video stream. With the present invention, if the user desires the parallel viewing method, he can easily adjust the distance between the two images for the best 3-D effect.

During the processing for all methods, the optional audio stream may be added at some point during the processing if desired.

Once completed, the digital three-dimensional video stream may be previewed on a display 32 if desired. Thus, preferably, early in the processing stage, at least a portion of the three-dimensional video stream is displayed so that one may view the quality of the produced three-dimensional video stream. If needed or desired, the input video streams may be adjusted. For the anaglyph, cross-eye and parallel methods, this may involve adjusting the side-by-side positioning of the two video streams. Additionally, for the anaglyph method, adjustments may be made to the changing to gray scale or the filtering of the video streams. For the shutter glass method, alignment of the two video streams side-by-side relationship may also be necessary. Additionally, the frame rates may be adjusted in order to improve the quality of the three-dimensional video stream.

If audio streams have been included with the three-dimensional video stream, this is also preferably included with the previews and any needed adjustments may be made to the audio stream at this time.

Once the user is happy with the three-dimensional video stream, the three-dimensional video stream, and any included audio stream, may be saved to a video file on, for example, RAM, ROM, a hard drive, a floppy disk, a compact disk or a DVD. Preferably, the video stream and audio stream are encoded prior to saving to a video file. Additionally, the three-dimensional video stream and audio stream may be uploaded to a website by streaming the three-dimensional video stream and audio stream to the website on the Internet. Alternatively, the three-dimensional video stream and audio stream may be streamed to a video chat location on the Internet if desired.

In an alternative embodiment, when the three-dimensional video stream, and if included, the audio stream, are satisfactory to the user, instead of saving the three-dimensional video or streaming it to the Internet, the two input video streams are instead saved in a video file. They may be saved in two files if desired, but it is preferable to save the two input digital video streams in a single file. Thus, no encoding is performed on the processor and thus, the central processing requirement is very low. This embodiment is especially useful for digital video camcorders. Since the digital video streams are from the digital video camcorders, no frames are dropped and thus, the two input digital video streams are of professional quality. Accordingly, in use, two input video streams from two digital video camcorders aligned in a side-by-side arrangement are processed to form a three-dimensional video stream. The three-dimensional video stream, or at least a portion thereof, is displayed in a preview window on a display device. A user may then adjust the camcorder alignment, or any other necessary parameters, in order to achieve a precise three-dimensional effect. Once the user is satisfied, the two digital video streams are saved to a video file and recording of the camcorders is complete.

The two video streams from video camcorders, such as, for example, DV, DVD, MPEG-4 or other high definition (HD), are already compressed. The two compressed video streams are saved to one file directly. They are uncompressed for the preview purposely only. Thus, this process requires little processing power, while keeping the file size small.

Accordingly, with this alternative embodiment, while especially useful for digital video camcorders, it is also especially useful for HD, MPEG-4 or DVD camcorders. The result is a file with two digital video streams.

Thus, the present invention provides a three-dimensional processing system and method that is software based. The present invention utilizes digital video signals, as opposed to analog signals, and has the ability to preview different three-dimensional processing methods, and thereby, their accompanying effects. The present invention is useful for providing three-dimensional photos, three-dimensional video footage, three-dimensional video streams for online purposes at Internet websites, three-dimensional video streams for online video chats, and displaying three-dimensional videos.

The present invention is relatively inexpensive compared to the prior art methods that utilize analog signals. Additionally, the present invention is capable of digital, software based anaglyph three-dimensional processing as opposed to the current hardware-based methods that utilize the shutter glass method, which with the hardware is generally expensive. A user is able to virtually instantly in real time view a preview of the resulting three-dimensional video stream. This allows for easy adjustments. Additionally, the present invention is flexible since it is a software-based solution. There is more flexibility than the current hardware-based solutions. For example, the software is capable of supporting numerous three-dimensional processing methods easily. The output may be a video file, web streaming, or an online chat, for example. Finally, the present invention may be portable if desired. For example, a processor in the form of a portable computer such as a laptop or notebook computer, may be taken “out in the field” with web cams or digital video camcorders, etc., thereby allowing for the ability to create and preview three-dimensional video streams on the spot.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of creating digital three-dimensional video information with a system comprising a processor, a user input and a display device, the method comprising:
providing first digital video information and second digital video information to the processor;
processing the first and second digital video information with the processor to create digital three-dimensional video information;
displaying at least a portion of the digital three-dimensional video information on the display device;
reviewing the portion of the digital three-dimensional video information; and
altering processing of the first and second video information based upon the review of the portion of the digital three-dimensional video information;
wherein processing of the first and second digital video information comprises merging the first and second digital video information; and
wherein altering processing of the first and second video information comprises adjusting alignment of the first and second video information for merging.

2. A method in accordance with claim 1 wherein the first and second digital video information are digital video streams and the digital three-dimensional video information is a digital three-dimensional video stream.

3. A method in accordance with claim 2 wherein the first digital video stream is provided by one of a group comprising a webcam, a digital video camcorder, a high definition camcorder, a DVD camcorder, a digital video file, an internet stream and an online chat stream, and the second digital video stream is provided by one of a group comprising a webcam, a digital video camcorder, a high definition camcorder, a DVD camcorder, a digital video file, an internet stream and an online chat stream.

4. A method in accordance with claim 3 wherein the first and second digital video streams are provided by a single digital video file that includes two separate video streams.

5. A method in accordance with claim 3 wherein the first and second digital video streams are provided by two separate digital video files.

6. A method in accordance with claim 2 wherein the user input controls at least one of providing the first and second digital video streams, the processing of the first and second digital video streams and altering of the processing of the first and second digital video streams.

7. A method in accordance with claim 2 further comprising providing a digital audio stream to the processor and including the digital audio stream with the three-dimensional video stream.

8. A method in accordance with claim 7 wherein the digital audio stream is provided by one of a microphone, a camcorder, a digital audio file, an audio stream from the internet, an audio stream from an online chat location and an analog source.

9. A method in accordance with claim 2 wherein the processing is done by a processing method from a group of three-dimensional processing methods comprising anaglyph, shutter glass, cross-eye and parallel.

10. A method in accordance with claim 9 wherein the processing is done by the anaglyph method and comprises the steps of changing to gray scale, adding a color filter to each of the first and second digital video streams, and overlaying the first and second digital video streams for merging the first and second digital video streams.

11. A method in accordance with claim 10 wherein the adding a color filter to each of the first and second digital video streams and overlaying the first and second digital video streams are performed substantially simultaneously.

12. A method in accordance with claim 11 wherein the changing to gray scale is performed substantially simultaneously with the adding a color filter to each of the first and second digital video streams and overlaying the first and second digital video streams.

13. A method in accordance with claim 2 wherein the first and second digital video streams are compressed and the method further comprises decoding the first and second digital video streams.

14. A method in accordance with claim 2 wherein the method further comprises saving the digital three-dimensional video stream as a video file on a processor-readable medium.

15. A method in accordance with claim 2 wherein the method further comprises uploading the digital three-dimensional video stream to a website.

16. A method in accordance with claim 2 wherein the method further comprises streaming the digital three-dimensional video stream to an online video chat address on the internet.

17. A method in accordance with claim 2 wherein upon completion of the digital three-dimensional video stream, the first and second digital video streams are saved on a processor-readable medium.

18. A system for creating digital three-dimensional video information, the system comprising:
a processor;
a source of first and second digital video information communicatively coupled to the processor;
a user input communicatively coupled to the processor;
a display communicatively coupled to the processor; and
a processor-readable medium including program code for processing the first and second digital video information to create digital three-dimensional information, program code for displaying a preview of the digital three-dimensional video information on the display, and program code for altering processing of the first and second video information;
wherein the user input may be used to alter processing of the first and second digital video information based upon the preview of the digital three-dimensional video information;
wherein processing of the first and second digital video information comprises merging the first and second digital video information; and
wherein altering processing of the first and second video information comprises adjusting alignment of the first and second video information for merging.

19. A system in accordance with claim 18 wherein the first and second digital video information are digital video streams and the digital three-dimensional video information is a digital three-dimensional video stream.

20. A system in accordance with claim 19 wherein the processor-readable medium is from a group comprising RAM, ROM and a harddrive.

21. A system in accordance with claim 19 wherein the processor-readable medium is portable.

22. A system in accordance with claim 19 wherein the source of first and second digital video streams is from a group comprising at least one of a webcam, a digital video camcorder, a high definition camcorder, a DVD camcorder, a digital video file, an internet stream and an online chat stream.

23. A system in accordance with claim 19 wherein the processor-readable medium includes program code for processing of the first and second digital video streams from a group of three-dimensional processing methods comprising anaglyph, shutter glass, cross-eye and parallel.

24. A system in accordance with claim 23 wherein the program code for three-dimensional processing is for the anaglyph method and comprises program code for changing to gray scale, adding a color filter to each of the first and second digital video streams, and overlaying the first and second digital video streams for merging the first and second digital video streams.

25. A system in accordance with claim 24 wherein the adding a color filter to each of the first and second digital video streams and overlaying the first and second digital video streams are performed substantially simultaneously.

26. A system in accordance with claim 25 wherein the changing to gray scale is performed substantially simultaneously with the adding a color filter to each of the first and second digital video streams and overlaying the first and second digital video streams.

27. A processor-readable medium containing program code for processing first and second digital video streams to create a digital three-dimensional video stream, the medium comprising:
program code for processing of the first and second digital video streams from a group of three-dimensional processing methods comprising anaglyph, shutter glass, cross-eye and parallel;
program code for displaying a preview of the digital three-dimensional video stream on a display; and
program code for altering processing of the first and second video streams based upon the preview;
wherein processing of the first and second digital video streams comprises merging the first and second digital video streams; and
wherein altering processing of the first and second video streams comprises adjusting alignment of the first and second video streams for merging.

28. A processor-readable medium in accordance with claim 27 further comprising program code for decoding compressed digital video streams.

29. A processor-readable medium in accordance with claim 27 further comprising program code for adding a digital audio stream to the digital three-dimensional video stream.
